(19) United States
(12) Patent Application Publication
(10) Pub. No.: US 2024/0383937 A1
(43) Pub. Date: Nov. 21, 2024

(54) TREATING BLACK LIQUOR WITH ACIDIC BIOMASS FOR LIGNIN RECOVERY

(71) Applicant: SUNCARBON AB, KARLSTAD (SE)

(72) Inventors: Daniela RUSANOVA-NAYDENOVA, LULEÅ (SE); Christer GUSTAVSSON, KARLSTAD (SE); Martin SUNDIN, ROKNÄS (SE); Marcus ELMER, HAMMARÖ (SE); Lars STIGSSON, KARLSTAD (SE); Philip HOWELLS, LYSEKIL (SE)

(21) Appl. No.: 18/578,859

(22) PCT Filed: Jul. 7, 2022
(86) PCT No.: PCT/SE2022/050694

§ 371 Date: Jan. 12, 2024

(30) Foreign Application Priority Data
Jul. 15, 2021 (SE) 2150944-3

(51) Int. Cl. C07G 1/00; D21C 11/00; D21C 11/02; D21C 11/12

(52) U.S. Cl. CPC C07G 1/00; D21C 11/0007; D21C 11/0042; D21C 11/02; D21C 11/125

(57) ABSTRACT

The present invention describes a method intended for lignin recovery, said method comprising: a step of mixing a stream of black liquor with an acidic biomass stream for providing a mixed heterogenous stream; a step of separating the mixed stream in a separation unit for providing one aqueous light phase stream and one lignin-containing heavy phase stream.

### FIELD OF THE INVENTION

The present invention relates to a method for lignin recovery, such as in the pulp and paper industry.

### TECHNICAL BACKGROUND

There are known methods relating to lignin recovery in pulp processing. One such method is disclosed in WO 2014/193289 in which there is disclosed a method for the treatment of spent pulping liquor for the separation of organic substances from aqueous cooking chemicals and the production of a solid lignin product, said method comprising passing a spent pulping liquor stream discharged from a digester or an evaporator section through filtration steps and then directing a stream concentrated with respect to organic compounds from the filtration to an acid treatment step for precipitation of at least lignin, and then directing a product flow comprising at least lignin from the acid treatment to a solid/liquid separation step in which a solid lignin containing product is separated and recovered.

The present invention is directed to an alternative and efficient way of recovering lignin, especially in subsequent pulp processing.

### SUMMARY OF THE INVENTION

The stated purpose above is achieved by a method intended for lignin recovery, said method comprising:
a step of mixing a stream of black liquor with an acidic biomass stream for providing a mixed heterogenous stream;
a step of separating the mixed stream in a separation unit for providing one aqueous light phase, stream and one aqueous lignin-containing heavy phase stream.

The present invention has the advantages of mixing two different streams to ensure control over the acidity level in the product stream and therefore also the degree of lignin recovery.

There are other existing and described ways for lignin purification and/or lignin recovery. Another such process is disclosed in WO 2020/013752, in which process lignin is purified by performing the following steps:
(a) providing lignin to be purified by acidifying black liquor, and subsequently separating the thereby formed raw lignin phase;
(b) dissolving the lignin in an acidic, aqueous solvent, at a temperature of at least 50° C. to provide a liquid one-phase system comprising dissolved lignin;
(c) triggering phase separation by diluting the one-phase system by adding water and/or by lowering the temperature of the one-phase system, to provide a two-phase system, and
(d) separating the lignin rich phase from the two-phase system to recover purified lignin.

In WO 2020/013752 it is stated that the black liquor may be acidified by applying pressurized carbon dioxide or adding sulfuric acid, either on its own or as supplement to carbon dioxide. This is one first important difference when comparing the present invention with the method disclosed in WO 2020/013752. According to the present invention there is no need to use additional acidifying agents, such as CO₂, SO₃, neat acids etc. for black liquor pretreatment. The acidic biomass stream, e.g., any type of pyrolysis oil, a fraction of pyrolysis oil or bio-crude as exemplified below is instead used as an in-situ acidifying component according to the present invention. Other differences and advantages of the present invention are further discussed below.

The acidic biomass stream is defined as a liquid stream obtained by thermochemical conversion of biomass. There are wide varieties of technical solutions and modes when practicing thermochemical conversion of biomass such as slow/intermediate/fast/flash pyrolysis, hydrothermal liquefaction, hydrothermal carbonisation, and the like, where typical products after the conversion are gas stream, acidic biomass stream and bio-char.

### BRIEF DESCRIPTION OF THE DRAWINGS

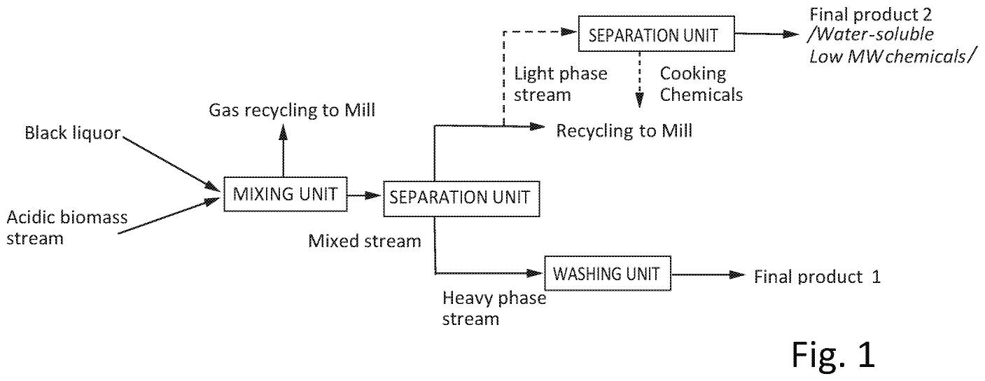

In FIG. 1 there is shown a schematic view of one embodiment according to the present invention.

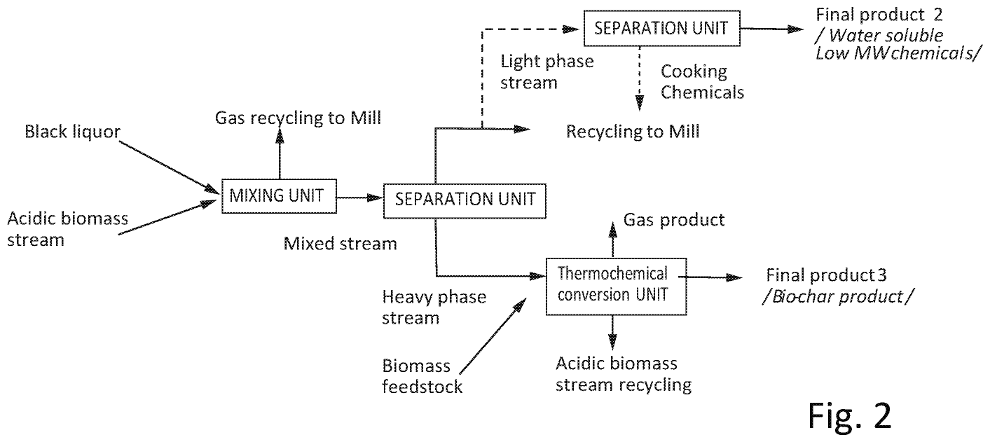

In FIG. 2 there is shown a schematic view of another embodiment according to the present invention, in this case with an alternative downstream processing in comparison to the embodiment shown in FIG. 1.

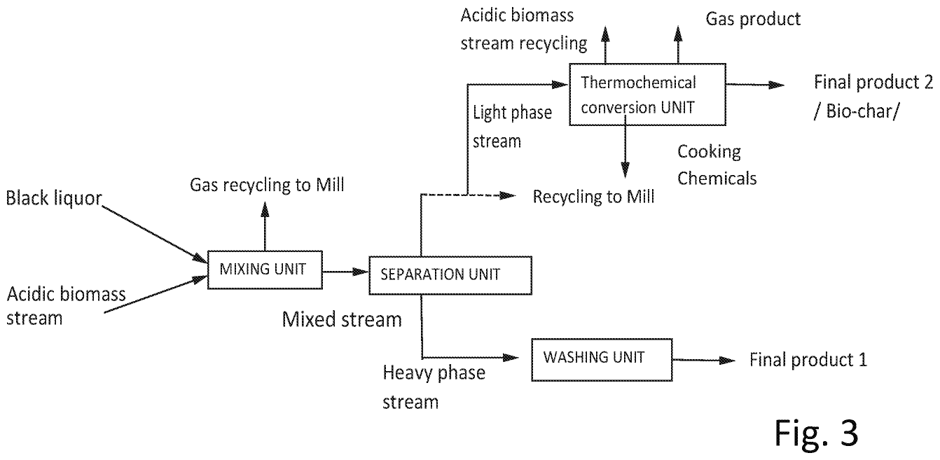

In FIG. 3 there is shown a schematic view of yet another embodiment according to the present invention, in this case with an alternative upstream processing in comparison to the embodiment shown in FIG. 1, wherein the light phase stream is transferred to a thermochemical conversion unit and bio-char product is obtained.

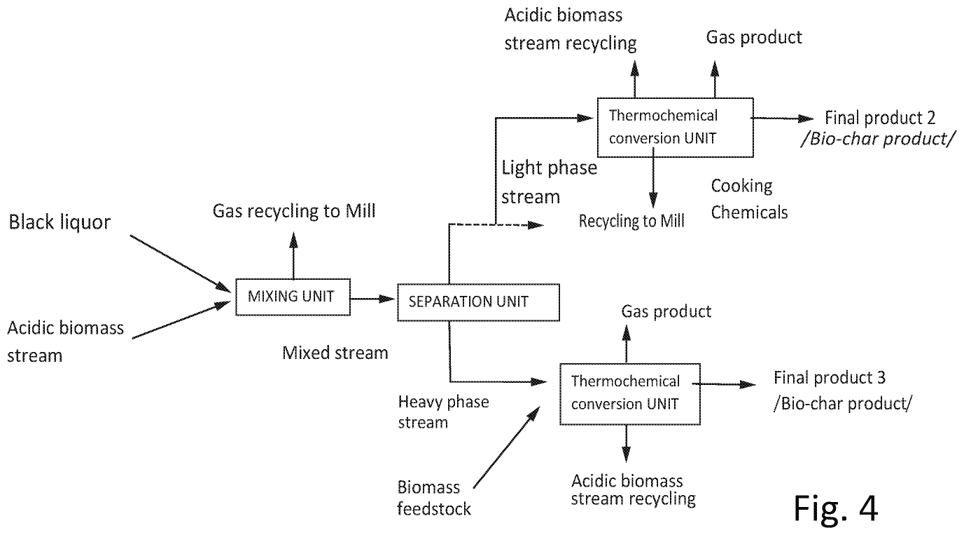

In FIG. 4 there is shown a schematic view of one further embodiment according to the present invention in this case with an alternative of both upstream and downstream processing in comparison to the embodiment shown in FIG. 1, wherein the light phase stream is transferred to a thermochemical conversion unit and bio-char product is obtained and heavy phase stream and/or the final product 1 in FIG. 1 are combined with biomass feedstock and transferred to thermochemical conversion unit.

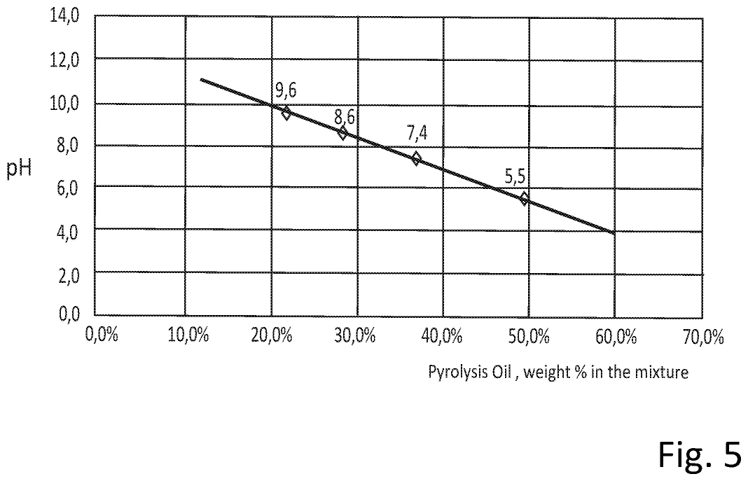

In FIG. 5 there is shown a graph for the natural affinity of spent black liquor-basicity to acidic biomass stream (pyrolysis oil) acidity during a mixing step performed according to the present invention.

### SPECIFIC EMBODIMENTS OF THE INVENTION

Below there is disclosed specific embodiments of the present invention.

The acidic biomass stream preferably is a liquid. Such streams are highly corrosive. A liquid stream is advantageous to use to enable efficient mixing with the black liquor stream. Moreover, according to yet another embodiment of the present invention, the acidic biomass stream is pre-treated and/or is combined with another stream before being mixed with the stream of black liquor. The biomass stream may e.g. be spiked with certain acids, suitably natural acids, such as acetic acid or formic acid or the like. This is not mandatory but may be used as a way to control the pH level of the biomass stream before being mixed with the black liquor stream. Alternatives to use as part of the acidic biomass stream are wood or barked derived acids, such as produced from thermal treatment of wood, sawdust or bark regardless if the acids are generated within a Kraft pulp mill environment or is imported to the plant.

It should further be mentioned that the acidic biomass stream used according to the present invention may be imported and is not necessary produced in a pulp mill environment. This may be true for the entire stream or part of it. Moreover, in the case of using pyrolysis oil/bio-crude or acidic streams from any type of thermochemical conversion units also such or part thereof may be produced inside or outside of the pulp mill suitable for the integration of a method according to the present invention.

Moreover, also other acids/acidic streams available in the pulp mill, which otherwise need to be neutralized before being discharged from the pulp mill, may also be used to support the acidity control needed according to the present invention. Some examples of such diluted acids are acidic streams generated in pulp bleaching steps (pH 4-5), residual acidic streams from tall oil plants, from wood chips steam pretreatment before the cooking process, or the like.

Moreover, according to yet another embodiment of the present invention, the spent pulp liquor is combined with another stream before being mixed with the acidic biomass stream. Again, this is not mandatory, but may be used as a way to maintain the pH level of the starting black liquor stream before being mixed with the biomass stream. Alternatives to use as part of the black liquor are aforementioned available mill diluted acidic streams with pH below 7. In line with the above, according to one embodiment, the stream of black liquor is combined with another mill stream of pH below 7 before being mixed with the acidic biomass stream. Based on the pH level it should be understood that also the mill stream is acidic.

According to yet another specific embodiment of the present invention, the acidic biomass stream is an acidic biomass liquid, preferably a bio crude, more preferably a pyrolysis oil, having a total acid number in a range of 20-210 mg KOH/g. The suitable acid number of the acidic biomass stream depends on several parameters, such as the intended pH level of the resulting mixed heterogenous stream, where around pH 7 often is a target, and of the flow ratio between the streams etc. As an example, at a total acid number of around 20 mg KOH/g for the acidic biomass stream, then this may have to be mixed with around half the flow/amount of black liquor. In the opposite corner, and more preferably, at a total acid number at a level of 210 mg KOH/g, then the ratio of black liquor to acidic biomass may be around 1:0.2.

In relation to the above it may be mentioned that the entire optimization above also depends on the pH level of interest and targeted end products, which is further discussed below. Moreover, the total acid number values mentioned relate to acidic biomass streams as obtained.

It should further be mentioned that the acidic biomass stream used according to the present invention may be characterized with a carboxylic acid number (CAN) too. The most general term used for characterisation of a compound acidity is the acid number (AN). That is also defined as the mass of potassium hydroxide (KOH) in milligrams that is required to fully neutralize one gram of acidic chemical substance. The carboxylic acid number reflects the acidity due to free organic carboxylic acids and can sometimes be named only as acid number, AN, too. The total acidic number (TAN) is a sum of carboxylic acid number and the acidity due to complex phenolic compounds (that are part of the pyrolysis/biocrude oil and of lignin residues). The total acid number shows the propensity of acidic biomass stream/acidic biomass fraction/acidic biomass products for corrosion but does not straightforward relate to corrosion properties. Corrosion is driven by water, hence pH values and carboxylic acid number are of importance for entire optimization of the process.

In line with the above, according to one embodiment of the present invention the acidic biomass stream has a carboxylic acid number (CAN) of more than 20 mg KOH/g, preferably at least 55 mg KOH/g and total acid number (TAN) of at least 145 mg KOH/g.

Moreover, according to yet another embodiment, wherein the acidic biomass stream is combined with another stream to a carboxylic acid number (CAN) of at least 55, more preferably at least 130 mg KOH/g, and a total acid number (TAN) of at least 145, more preferably at least 235 mg KOH/g before being mixed with the stream of black liquor.

Moreover, pre-treatment of acidic biomass stream would be expected to increase both the carboxylic acid number and total acid number correspondingly. Hence it may be used as a tool for lignin recovery process optimisation.

According to one embodiment of the present invention, the acidic biomass liquid comprises at least one fraction of pyrolysis oil and has a carboxylic acid number in a range of 20-200 mg KOH/g. In this regard it may also be mentioned that for example during pyrolysis oil production one may condense the main gas streams/products at once, at a given temperature. Therefore, it is possible to obtain a non-fractionated pyrolysis oil product to be used according to the present invention. Another possible way is that one condenses the stream in several steps, each step at a different temperature (lower than the previous). In this case, there are obtained fractions enriched with specific components. Yet another possible way to fractionate pyrolysis oil is to utilize differences in solubility in various solvents between different fractions. In this regard it should be mentioned that any type or a mixture of different pyrolysis oil fractions are possible to use according to the present invention.

According to yet another specific embodiment of the present invention, the acidic biomass stream is a biogenic gas. To give one example, such a biogenic gas may be a gas generated during wood or bark treatment. Also other gases may be used, either being produced in a pulp mill environment or e.g. from other nearby bio-based industries, such as from bio-ethanol production.

According to yet another specific embodiment of the present invention, the acidic biomass stream could be considered as synergetic acidic stream comprised of acidic streams in both gaseous and liquid state.

These can be applied together but advantageously are used in a sequence when treating black liquor liquid stream. As an example of such sequence is where biogenic gas is first used to adjust the pH level of the black liquor stream and thereafter liquid biomass stream is applied to further decrease the pH levels of the combined black liquor-biogenic gas stream or any secondary streams or products thereof.

As mentioned above, the method according to the present invention is intended in connection with pulping processes. Therefore, according to one embodiment, the stream of black liquor is a stream from a Kraft or SODA pulping process. Furthermore, according to yet another embodiment, the method is integrated and operated in a pulp mill, preferably in a Kraft or SODA pulping process.

Furthermore, and as a continuation of the above, according to one embodiment of the present invention, one step involves mixing a stream of black liquor with an acidic biomass stream in a ratio of from 1:0.2 to up to 1:10 on black liquor:acidic biomass, preferably at least a ratio of 1:1 on black liquor:acidic biomass, more preferably at least a ratio of 1:0.5 on black liquor:acidic biomass. Furthermore, according to yet another embodiment, the step involves mixing a stream of black liquor with an acidic biomass stream in ratio based on the total acid number of the acidic biomass, preferably from a ratio of 1:0.2 on black liquor:acidic biomass at a total acid number of 210 mg KOH/g of the acidic biomass to a ratio of 1:2 on black liquor:acidic biomass at a total acid number of 20 mg KOH/g of the acidic biomass.

In any of the chosen ratios the mixture would be expected to show lignin content of minimum 10%. Successful isolation of that lignin containing black liquor oil of pyrolysis product would depend on the pH of the system and its heterogeneity level.

Furthermore, and in line with the above, according to one embodiment, the mixed heterogenous stream has a lignin content of at least 10% when being introduced into the separation unit. In this regard it may be noted that 10% corresponds to a ratio of 1:0.2 on black liquor:acidic biomass.

Regarding the ratio mentioned above, the following may also be mentioned.

First of all, different acidity of the acidic biomass stream, such as the pyrolysis oil/bio crude, will determine different pH levels and the total acid number of the mixed heterogenous stream and also of separated streams therefrom. Moreover, also different compositions of the black liquor have an effect on this question, but also on the degree of the heterogeneity of the resulting mixed stream. This also has an effect on the subsequent separation and also stability of separated streams, such as the separated heavy stream (further discussed below).

Also other parameters may be of interest to optimize the present invention. One such is the temperature, such as in the mixed heterogenous stream. According to one specific embodiment of the present invention, the temperature of the mixed heterogenous stream is kept in the range of 20-120° C., preferably in the range of 20-80° C., more preferably in the range of 30-50° C., already at the step of mixing and thus production of the mixed heterogenous stream. This also implies that the method according to the present invention is not intended to be involved in a hydrogenation process, such as certain background technologies.

Furthermore, as a continuation from above according to yet another embodiment the purified black liquor oil of pyrolysis product can be obtained as a solid material at standard temperature and pressure, (STP), and/or at normal temperature and pressure (NTP).

Another technical parameter of great relevance is the separation technology. According to one preferred embodiment, the separation unit comprises at least one centrifuge. It should be mentioned that also other technologies may be used, either alone or in connection with one or more centrifuges. One alternative is a decanting unit. Here it may also be mentioned that the inflowing streams may set the choice of separation technology. The combinations of separation technologies may also be a relevant choice according to the present invention aiming separation by density differences. Based on this, according to one embodiment of the present invention, the separation unit operates via separation by density differences. As examples, decanter and/or centrifuge units may be used.

Also the intended streams after separation has a great relevance for the total process according to the present invention.

According to one specific embodiment, the separated lignin-containing heavy phase stream has a total acid number in a range of 1-10 mg KOH/g.

According to yet another embodiment of the present invention, the aqueous light phase stream has a lignin content of at least 5% at a pH level of at least 4, preferably when the aqueous light phase stream has a pH level in the range of 5-9, more preferably a pH level in the range of 7-8.5. This type of levels is suitable to ensure a further use and recirculating of this stream. As a continuation of this, according to one embodiment of the present invention, the aqueous light phase stream comprises cooking chemicals, preferably which at least partly are recirculated in a Kraft or SODA pulping process plant, optionally subsequent to extraction of a stream from the aqueous light phase stream. In this regard it may also be mentioned that pH levels above 4 are preferred to ensure that such stream is not too corrosive when being recirculated back in a pulp mill and also contains at least 5% unrecovered lignin.

Moreover, according to yet another embodiment of the present invention, the aqueous light phase stream has a lignin content of no more than 5% at a pH level of below 4, preferably when the aqueous light phase stream has a pH level in a range of 2.5-4, and wherein the mixing of a stream of black liquor with an acidic biomass stream is performed in a ratio up to 1:10 on black liquor:acidic biomass. This type of levels is suitable to ensure nearly total lignin precipitation and recovery (at least 95%). Again, this is not mandatory, but may be used as a way to control the pH level with respect to amount of lignin recovered. Such an alternative would require further steps for mill integration.

The pH level of the light phase stream may also be seen as an indicator of the lignin content in that stream. As an example, at a higher pH level, such as around 7-8 then some lignin is still in this stream also after the separation. In some case this may be relevant to ensure a good chemical integration in a mill, especially for the energy balance of the mill. It should, however, be clearly stated that removing much of the lignin is beneficial for a pulp mill as a whole.

As hinted above, in addition to the recirculation of the light phase stream also separation of certain chemicals may be performed. According to one embodiment of the present invention, water-soluble valuable organic compounds with a molecular weight below 200 g/mole are at least partially isolated from the aqueous light phase stream before said stream comprising cooking chemicals are recycled as shown in FIGS. 1 and 2. These compounds or a part-containing such may be separated off and captured to be either handled as a final product or reused at a suitable place in a connecting process.

Furthermore, the light phase stream having at least 5% lignin content can be subjected to wet thermochemical conversion treatment such as hydrothermal carbonization and/or hydrothermal liquefaction or the like at sub- or supercritical temperatures and pressures before said stream comprising cooking chemicals are recycled. In that sense, a secondary bio-crude/acidic biomass stream, organic-rich biochar, and some gases would be produced too as shown in FIG. 3. In line with the above, according to one embodiment of the present invention, the aqueous light phase stream is subjected to wet thermochemical treatment at sub- or supercritical temperatures and pressures where an organic-rich biochar is produced.

According to yet another embodiment of the present invention, the lignin-containing heavy phase stream is purified, preferably transferred to a washing unit, more preferably a washing unit based on washing the lignin-containing heavy phase stream in an aqueous stream, most preferably a counter-current aqueous stream. One such example is shown in FIG. 1. This washing unit may comprise several washing units, such as several operating with a counter-current washing medium, suitably aqueous medium. Moreover, according to yet another embodiment of the present invention, the aqueous washing may contain either only water or available mill streams with pH below 7. Again, this is not mandatory, but may be used to ensure easier integration of the process into the mill.

Moreover, according to yet another embodiment, the lignin-containing heavy phase stream is purified to produce a purified black liquor oil of pyrolysis product containing 10-50 wt. % water, preferably 10-30 wt. % water. As hinted, preferably the lignin-containing heavy phase stream has a pH level in a range of 4-8, a reduced total acid number relative to the total acid number of the acidic biomass stream and a reduced inorganic content relative to the inorganic content in the black liquor stream. This black liquor oil of pyrolysis product is shown as a final product 1 in FIG. 1.

According to yet another embodiment, the lignin-containing heavy phase stream is sent to a thermochemical conversion unit/pyrolysis unit in which there is produced a bio-char product, optionally also a gas product and an acidic biomass stream, preferably said acidic biomass stream is recycled to a pulp mill directly or as part of the starting acidic biomass stream. This can be applied as described but advantageously can also be used when the final product 1 is fed to the pyrolysis unit i.e. after the washing unit.

Moreover, according to another embodiment of the present invention, the lignin-containing heavy phase stream is transferred to a pyrolysis step, preferably the pyrolysis step produces a stream comprising an acidic biomass with total acid number more than 1 mg KOH/g, preferably at least 10 mg KOH/g, more preferably in the range of 20-210 mg KOH/g, more preferably the stream comprising lignin is used as at least part of or recirculated to an acidic biomass stream used in the step of mixing. One such alternative is shown in FIG. 2, where a pyrolysis unit of any type of pyrolysis process (slow/intermediate/fast/flash or the like) is provided.

Furthermore, according to yet another embodiment, the lignin-containing black liquor oil of pyrolysis product is transferred to a thermochemical conversion unit and optionally combined with biomass feedstock and subjected to a conversion step, preferably the pyrolysis step, produces a lignin enriched bio-char product. Such alternatives are shown in FIG. 2 and FIG. 4, where a pyrolysis unit of any type of pyrolysis process is led.

### DETAILED DESCRIPTION OF THE DRAWINGS

In FIG. 1 there is shown a schematic view of one embodiment according to the present invention. As may be seen, a stream of black liquor is mixed with an acidic biomass stream. The mixing may be performed in a suitable mixing unit, suitably mixing the two streams in a counter-current principle. Suitably the temperature is held in a range of 20-80° C., preferably around 30-50° C. Produced gases are separated off. This may be performed by use of vacuum. It should, however, be noted that this depends on the pH chosen and/or mixing ratio. As one example, also pressurization may be used to keep at least part of the gases in the stream to keep pH at a lower level, such as around 7. Moreover, to include a degassing tank is also a possible option. It should be noted that certain centrifuges of interest according to the present invention does not explicitly tolerate gases, while such have to be removed before the separation step if that is the chosen separation technique.

As mentioned, different type of separation technologies based on density difference may be used. At this separation, the heterogenous mixed stream is divided into one light phase stream and one heavy phase stream. The light phase stream may then be recycled back to a pulp mill, such as directly, partly or after yet another separation step such as indicated in the embodiment shown in FIG. 1. According to the embodiment shown in FIG. 1, this latter separation divides the light phase stream into cooking chemicals, which are recycled to the pulp mill, and a stream of certain valuable low molecular weight (MW) organic compounds (see final product 2 in both FIGS. 1 and 2). These compounds are water-soluble and may be isolated before the light phase stream being recirculated back to the pulp mill.

The heavy phase stream may be handled in different ways. According to the embodiment shown in FIG. 1, this stream is sent to a washing unit, suitably involving counter-current washing in a water flow. After the washing a black liquor oil of pyrolysis product is obtained in the form of a solid lignin at STP (see final product 1 in FIG. 1). This new product may be considered as a pulp mill's own fuel and/or a fuel in general. Either it may be used in the pulp mill or may be mixed with different fuel components and suitably then hydrogenated to different boiling point fuel fractions.

Furthermore, in FIG. 2 there is shown a schematic view of another embodiment according to the present invention, in this case with an alternative downstream processing in comparison to the embodiment shown in FIG. 1. In this case the heavy phase stream is sent to a thermochemical conversion unit/pyrolysis unit. In this pyrolysis unit there is obtained a final product 3, a bio-char product. Furthermore, from the pyrolysis unit, there is also obtained a gas product, a non-condensable gas, e.g. syngas as exemplified in FIG. 2, and an acidic biomass stream, which may be recycled and e.g. be used in the pulp mill directly or as part of the starting material in the method according to the present invention. Yet another alternative for downstream processing includes addition of biomass to the thermochemical conversion unit along with the heavy phase stream.

In FIG. 3 there is shown a schematic view of yet another embodiment according to the present invention, in this case with an alternative upstream processing in comparison to the embodiment shown in FIG. 1. In this case the light phase stream is transferred to a thermochemical conversion unit and bio-char product is obtained (instead of low MW chemicals) along with the gaseous product and the acidic biomass recycled stream.

In FIG. 4 there is shown a schematic view of one further embodiment according to the present invention, and in this case with an alternative of both upstream and downstream processing in comparison to the embodiment shown in FIG. 1. Here the light phase stream is transferred to a thermochemical conversion unit and bio-char product; gaseous product and acidic recycled stream are obtained (instead of low MW chemicals as in FIG. 1) before the cooking chemicals are recycled to the Mill. Moreover, the heavy phase stream alone and/or the final product 1 in FIG. 1 is fed into a thermochemical conversion unit together with the initial biomass feedstock for isolating biochar and gaseous products along with the acidic biomass stream that could be recycled.

The present invention has several advantages and possible purposes. As a general statement, the method according to the present invention results in valuable bio-mass components being extracted and possible to use or reuse (recirculate) and which method at the same time may be integrated in a pulp mill without disturbance of the mill-chemicals recycling circle along with off-loading the recovery boiler.

The present invention is directed to stripping the main mixing streams of their disadvantages, by reducing the basicity of the black liquor and reducing the acidity of the used biomass stream, such as a pyrolysis oil as seen in FIG. 5. This further implies that the present invention forms the foundation to mixing a water-based cooking liquor with oil-based carrier stream to ensure that wood components obtained in a different way get together again in a stable stream that can be separated from cooking chemicals.

Moreover, the process according to the present invention only contains standard operations, such as mixing and separation, and suitably aqueous washing.

Moreover, according to yet another embodiment of the present invention, the aqueous washing may contain either only water or available mill streams with pH below 7. Again, this is not mandatory, but may be used to ensure easier integration of the process into the mill. Alternatives to use as part of washing are aforementioned available mill diluted acidic streams. This is also beneficial, such as when being compared with other lignin recovery technologies. Furthermore, no new chemicals are introduced with reference to chemicals being used in a pulp mill. Fact is that the method according to the present invention enables for a pulp mill to be more or less self-sustainable. With e.g. an integrated pyrolysis unit, and existing large amount of wood residues possible to utilize, then a pulp mill may produce its own fuel to be used.

Moreover, and as evident form the specific embodiments described above, the process according to the present invention can be regarded as modular concept that could be tailored to specifics of pulp mills. In other words, the complexity level of downstream processing options for heavy-phase and light phase, obtained according to the present invention, can vary depending on the particular pulp mill. Thus, in one case the pulp mill might be targeting the maximum production of final product 1, whereas the light phase is only recycled to the mill without focusing on the recovery of low molecular weight components. In other cases, the light phase might also be of interest for upgrading either through isolation of the low molecular weight components or thermochemical conversion to entirely new product i.e., the bio-char.

To summarize, when being compared with other technologies intended for lignin recovery from black liquor, the method according to the present invention has the following advantages:
There is no categorical need to use additional acidifying agents to the starting black liquor, such as CO₂, SO₃, neat acids etc. As mentioned, the acidic biomass steam, such as pyrolysis oil/fraction of pyrolysis oil/bio-crude acts as an in-situ acidifying component.
There is no strong demand to oxidize the black liquor in advance, and thus there is no need to use oxygen.
Furthermore, according to the present invention there is no apparent prerequisite to introduce more neat acid during washing the heavy lignin phase stream and hence the Na/S balance of a pulp mill is maintained. Available mill streams with pH below 7 may be utilised if needed. Today, most used acid for lignin isolation/washing is H₂SO₄ as it is a low-cost chemical, but this creates the need for NaOH-make-up further in the process of integration to the Na/S circles of pulp mills, as well as building units that produce the acid.
Fact is that water is more likely to be only needed for washing of the raw product obtainable by the method according to the present invention (see heavy phase stream of FIG. 1)
Moreover, the method according to the present invention provides the possibility of returning the cooking chemicals to a pulp mill without considerably changing their chemical state but still keeping the pH-value in the basic range (pH>7), which is the general preference in a pulp mill. Again, there is no obvious necessity for NaOH make up to be given back to the pulp mill if that alternative for pH is chosen.
There is no need of additional solvent(s) and/or surfactants (additives) to be added to the lignin product for its conversion into a final stream according to the present invention.
Once the two streams are mixed in the method according to the present invention, the aqueous light-phase is naturally only slightly miscible with the heavy-lignin phase. That ensures to use a simple separation process based on density difference (e.g. a decanter tank or a centrifuge) and that main amount of cooking chemicals are being separated from heavy lignin-stream to a very high degree.
According to the present method, separated process-water can be partially used for dilution of the starting black liquor-feed and/or partially evaporated in an evaporator unit of a pulp mill. Another possibility is to be used in a biological-passage of wastewater treatment plant (WWTP) facility as it contains some low MW compounds that might be beneficial for bacteria (as a potential nutrition component), thus it can be seen that the process-water stream is suitable for biochemical processing.
Moreover, the gases if released during mixing of black liquor and the acidic biomass stream could directly be returned to the pulp mill (in a lime kiln and/or boiler) and used as an energy gas.

Furthermore, the obtained products of the method according to the present invention also have advantages. A first example is the black liquor oil of pyrolysis product (final product 1 in FIG. 1). This product isolation provides a lowering of the acidic level in the biomass starting material, which is beneficial for subsequent steps.

To also summarize this perspective, at least the following may be mentioned:
The pure black liquor oil of pyrolysis product obtainable according to the present invention may be expected to be processed in any type of fossil-refinery when mixed with other fuel fractions. When compared, use of pyrolysis oil itself as a renewable feedstock at conventional refineries is hindered by its main disadvantage, the very high acidity.
If the black liquor oil of pyrolysis product is transferred into a slow/intermediate/fast or flash pyrolysis unit or the like as exemplified in FIGS. 2 and 4, then the obtained bio-char would be expected to be of considerably higher quality in comparison to other bio-chars and might be also slightly basic in nature. That particular property would make it possible to use as an additive to acidic soils (typical for any mining regions worldwide, including north Sweden). Soil additive usage is a main track for bio-char utilization if large scale pyrolysis units are built, although its potential as bio-coal source has been recognized by steel industry.
The non-condensable-gases obtained from a pyrolysis unit according to FIGS. 2 and 4 would also be expected to be cleaner in comparison to standard pyrolysis gases and could possibly be used as fuel/electricity generation directly.
The low molecular weight components that could be isolated from the light-stream (see final product 2) are valuable for resin-, fertilizer-, food-flavoring- and bio-ethanol production industries.

1. A method intended for lignin recovery, said method comprising:
a step of mixing a stream of black liquor with an acidic biomass stream for providing a mixed heterogenous stream;
a step of separating the mixed stream in a separation unit for providing one aqueous light phase stream and one aqueous lignin-containing heavy phase stream.

2. The method according to claim 1, wherein the acidic biomass stream is a liquid stream.

3. The method according to claim 1, wherein the mixed heterogenous stream has a lignin content of at least 10% when being introduced into the separation unit.

4. The method according to claim 3, wherein the acidic biomass stream has a carboxylic acid number (CAN) of more than 20 mg KOH/g, preferably at least 55 mg KOH/g and total acid number (TAN) of at least 145 mg KOH/g.

5. The method according to claim 1, wherein the acidic biomass stream is combined with another stream to a carboxylic acid number (CAN) of at least 55, more preferably at least 130 mg KOH/g, and a total acid number (TAN) of at least 145, more preferably at least 235 mg KOH/g before being mixed with the stream of black liquor.

6. The method according to claim 1, wherein the stream of black liquor is combined with another mill stream of pH below 7 before being mixed with the acidic biomass stream.

7. The method according to claim 1, wherein the acidic biomass stream is an acidic biomass liquid, preferably a bio crude, more preferably a pyrolysis oil, having a total acid number in a range of 20-210 mg KOH/g.

8. The method according to claim 7, wherein the acidic biomass liquid comprises at least one fraction of pyrolysis oil and has a carboxylic acid number in a range of 20-200 mg KOH/g.

9. The method according to claim 1, wherein the acidic biomass stream is a biogenic gas.

10. The method according to claim 1, wherein the stream of black liquor is a stream from a Kraft or SODA pulping process.

11. The method according to claim 1, wherein the method is integrated and operated in a pulp mill, preferably in a Kraft or SODA pulping process.

12. The method according to claim 1, wherein the step of mixing involves mixing a stream of black liquor with an acidic biomass stream in a ratio of from 1:0.2 up to 1:10 on black liquor:acidic biomass, preferably at least a ratio of 1:1 on black liquor:acidic biomass, more preferably at least a ratio of 1:0.5 on black liquor:acidic biomass.

13. The method according to claim 1, wherein the step of mixing involves mixing a stream of black liquor with an acidic biomass stream in ratio based on the total acid number of the acidic biomass, preferably from a ratio of 1:0.2 on black liquor:acidic biomass at a total acid number of 210 mg KOH/g of the acidic biomass to a ratio of 1:2 on black liquor:acidic biomass at a total acid number of 20 mg KOH/g of the acidic biomass.

14. The method according to claim 1, wherein the temperature of the mixed heterogenous stream is kept in the range of 20-120° C., preferably in the range of 20-80° C., more preferably in the range of 30-50° C., already at the step of mixing and thus production of the mixed heterogenous stream.

15. The method according to claim 1, wherein the separation unit operates via separation by density differences.

16. The method according to claim 1, wherein the separated lignin-containing heavy phase stream has a total acid number in a range of 1-10 mg KOH/g.

17. The method according to claim 1, wherein the aqueous light phase stream has a lignin content of at least 5% at a pH level of at least 4, preferably when the aqueous light phase stream has a pH level in the range of 5-9, more preferably a pH level in the range of 7-8.5.

18. The method according to claim 1, wherein the aqueous light phase stream has a lignin content of no more than 5% at a pH level of below 4, preferably when the aqueous light phase stream has a pH level in the range of 2.5-4, and wherein the mixing of a stream of black liquor with an acidic biomass stream is performed in a ratio up to 1:10 on black liquor:acidic biomass.

19. The method according to claim 1, wherein the aqueous light phase stream comprises cooking chemicals, preferably which at least partly are recirculated in a Kraft or SODA pulping process plant, optionally subsequent to extraction of a stream from the aqueous light phase stream.

20. The method according to claim 19, wherein water-soluble valuable organic compounds with a molecular weight below 200 g/mole are at least partially isolated from the aqueous light phase stream before said stream comprising cooking chemicals are recycled.

21. The method according to claim 1, wherein the lignin-containing heavy phase stream is purified, preferably transferred to a washing unit, more preferably a washing unit based on washing the lignin-containing heavy phase stream in an aqueous stream, most preferably a counter-current aqueous stream.

22. The method according to claim 21, wherein the lignin-containing heavy phase stream is purified to produce a purified black liquor oil of pyrolysis product containing 10-50 wt. % water, preferably 10-30 wt. % water.

23. The method according to claim 22, wherein the purified black liquor oil of pyrolysis product is a solid material at standard temperature and pressure, (STP).

24. The method according to claim 21, wherein the lignin-containing heavy phase stream is sent to a thermochemical conversion unit in which there is produced a bio-char product, optionally also a gas product and an acidic biomass stream, preferably said acidic biomass stream is recycled to a pulp mill directly or as part of the starting acidic biomass stream.

25. The method according to claim 1, wherein the lignin-containing heavy phase stream is transferred to a pyrolysis step, preferably the pyrolysis step produces a stream comprising an acidic biomass with total acid number more than 1 mg KOH/g, preferably at least 10 mg KOH/g, more preferably in the range of 20-210 mg KOH/g, more preferably the stream comprising lignin is used as at least part of or recirculated to an acidic biomass stream used in the step of mixing.

26. The method according to claim 1, wherein the aqueous light phase stream is subjected to wet thermochemical treatment at sub- or supercritical temperatures and pressures where an organic-rich char is produced.
